(19) United States
(12) Patent Application Publication
(10) Pub. No.: US 2004/0177921 A1
(43) Pub. Date: Sep. 16, 2004

(54) Joining method using anisotropic conductive adhesive

(76) Inventor: Akira Yamauchi, Shiga (JP)

Correspondence Address: SMITH PATENT OFFICE, 1901 PENNSYLVANIA AVENUE N W, SUITE 200, WASHINGTON, DC, 20006

(21) Appl. No.: 10/482,079

(22) PCT Filed: Jun. 28, 2002
(86) PCT No.: PCT/JP02/06605

(30) Foreign Application Priority Data
Jun. 29, 2001 (JP) 2001-199502

(51) Int. Cl. B32B 31/00

(52) U.S. Cl. 156/277

(57) ABSTRACT

A bonding method using an anisotropic conductive adhesive, comprising the steps of forming an adhesive coating layer (4) on and along the surface (1a), having metal joint parts (2), of at least one (1) of objects to be bonded when bonding objects with metal joint parts to each other, spreading conductive particles (5) onto the surface (4a) of the adhesive layer, and thereafter bonding the metal joint parts to each other. The method can efficiently restrict conductive particles from escaping from bonding portions before and during bonding the objects to each other, ensure a sufficient number of conductive particles between the metal joint parts to be bonded to each other, and prevent conductive particles causing short circuiting from existing between adjacent metal joint parts, and easily accommodate the fining and fine pitching of metal joint parts.

### TECHNICAL FIELD OF THE INVENTION

The present invention relates to a method for bonding objects with metal joint parts to each other using an anisotropic conductive adhesive, and specifically to a bonding method using an anisotropic conductive adhesive suitable for mounting of an object on which fine metal joint parts are disposed at a fine pitch.

### BACKGROUND ART OF THE INVENTION

For example, a mounting method for bonding objects, at least one of which has bumps, to each other by heating, pressing, etc. is well known. As a typical method, a method for bonding them via an anisotropic conductive adhesive containing conductive particles is known. Usually, in this bonding method, an anisotropic conductive adhesive containing conductive particles beforehand is interposed between objects by coating and the like, the electrical connection is ensured by nipping the conductive particles between bumps or between bumps and electrodes by heating or pressing, and the electric insulation and the sealing property relative to outside are ensured by curing the adhesive component existing around the electrically connected portions.

However, recently, fine pitching of bumps provided as metal joint parts, and reduction of bump area (bump size) accompanying with it, have been required, and therefore, such a requirement has not been able to be accommodated merely by coating an anisotropic conductive adhesive containing the above-described conductive particles. Namely, if bumps are fine-pitched, an adhesive present between objects flows when the objects are bonded to each other, accompanying therewith, conductive particles escape from the portion between the bumps to be bonded to each other and the number of the conductive particles nipped therebetween reduces, and the electrical connection cannot be achieved at a high reliability. Further, because a distance between adjacent bumps is small, conductive particles are unevenly distributed at the portion between bumps, the number of the conductive particles in this portion becomes great, and a short circuiting may occur.

In order to accommodate such a fine pitching of bumps, an anisotropic conductive film, wherein conductive particles are uniformly distributed on its surface, is known (JP-A-2000-151084). Further, a bonding method is also known, wherein an adhesive is coated only onto bumps or electrodes to be bonded, and conductive particles are adhered to the adhesive (JP-A-2000-307221).

In the above-described method disclosed in JP-A-2000-151084, however, because conductive particles are distributed on a surface of a substantially already formed film, even if a uniform state can be achieved at the time of the distribution, at the stage of mounting, the conductive particles move by the flow of a film component ascribed to heating and pressing the bumps, some conductive particles escape from the portion between the bumps to be bonded to each other to portions therearound, it becomes difficult to ensure a sufficient number of conductive particles nipped therebetween, and bonding between the bumps at an electrically high reliability may be difficult. Therefore, in this method, there is a limit to accommodate fine pitching of bumps. Further, there is a fear of a short circuiting due to conductive particles which have escaped to circumferential portions.

In the above-described method disclosed in JP-A-2000-307221, although adhesive and conductive particles can be disposed locally the portions of bumps or electrodes to be bonded, because the conductive particles are adhered so that they cover (surround) the bumps or electrodes, in a case where the distance between adjacent bumps or electrodes is very small, the conductive particles may be interposed therebetween, and a short circuiting may occur. Therefore, it is difficult to accommodate such a fine pitching as a pitch of 35 μm or less which has been required recently. Further, since an adhesive and conductive particles are locally disposed only on the portions of bumps or electrodes, it is necessary to inject an underfill agent for filling up the gap between both objects in order to ensure a sufficient insulation property relative to outside, but it is very difficult in practice to inject the underfill agent so as to fill up the fine gap. If the underfill agent is forcibly injected, conductive particles having adhered to bumps or electrodes move accompanying with the injection of the underfill agent, and it becomes difficult to ensure a good electrical connection state to be expected.

### DISCLOSURE OF THE INVENTION

Accordingly, paying an attention to the limit in the above-described conventional technology, a purpose of the present invention is to provide a bonding method using an anisotropic conductive adhesive which can efficiently suppress conductive particles from escaping from bonding portions before and during bonding objects to each other, ensure a sufficient number of conductive particles between metal joint parts to be bonded to each other, and prevent conductive particles causing short circuiting from existing between adjacent metal joint parts, thereby accommodating the fining and fine pitching of metal joint parts more surely.

To accomplish the above-described purpose, a bonding method using an anisotropic conductive adhesive according to the present invention is herein provided. The method is for bonding objects each having metal joint parts to each other, and the method comprises the steps of forming an adhesive coating layer on and along a surface, having the metal joint parts, of at least one of the objects; spreading conductive particles onto a surface of the adhesive layer; and then bonding the metal joint parts to each other.

In the present invention, the “object” includes all objects for which an electrical connection is performed using an anisotropic conductive adhesive, and for example, it means a formation such as an IC chip, a semiconductor chip, an optoelectronic element, a resin substrate, a glass substrate, film substrate, etc. Further, the “metal joint part” means a convex-type or buried-type bonding part formed on a surface of an object in order to achieve a predetermined electric connection between objects bonded to each other, it includes a bump-form part and an electrode and the like having a predetermined-shape (for example, flat-shaped) top surface. This “bump” means a convex joint part formed on the surface of at least one of the objects in order to achieve the predetermined electric connection between objects bonded to each other, and although it is usually called as “bump”, there is a case where it is called merely as “electrode”.

Further, as the method for spreading conductive particles, for example, except a mere spreading method, there are a spreading method utilizing a magnetic field or an electrical charging, a spreading method utilizing filling into mesh holes, a spreading method utilizing a screen printing, a spreading method utilizing a surface tension, etc. Among these methods, a method is preferred for charging the conductive particles at a substantially same electric charge and then spreading them.

In the above-described bonding method according to the present invention, the conductive particles may be spread substantially onto the entire surface of the adhesive layer, and after performing a predetermined masking relatively to the surface of the adhesive layer, the conductive particles may be spread onto non-masking portions corresponding to positions of the metal joint parts. This masking may be performed by using a perforated plate, or by selectively changing tack properties between surface portions of the adhesive layer by an optical masking, for example, exposure (for example, ultraviolet-ray exposure). Further, it is preferred that portions to which the above-described masking is performed include a mark portion for alignment of the object. In such a method, when the alignment mark is read by a recognition means, it is prevented to confuse the alignment mark and the conductive particles, and it becomes possible to read the alignment mark more accurately.

The above-described metal joint part may be formed as a form of a bump, and may be formed as a form of an electrode on a circuit which has a flat surface. Therefore, when the masking is performed in the above-described manner, the conductive particles can be spread relatively to the surface of the adhesive layer positioned above the bump. Further, a method can also be employed wherein a masking is performed and the conductive particles are spread onto the flat surface of the adhesive layer positioned above the electrode on a circuit of an object, and in this case, it is possible to achieve a bumpless formation.

Further, in the above-described bonding method using an anisotropic conductive adhesive according to the present invention, although the adhesive is served to bonding process as the adhesive is left to be non-cured, a method may be employed wherein, after the conductive particles are spread or after the spread conductive particles are pushed into the adhesive layer, the surface of the adhesive layer (for example, the entire surface) or the entire adhesive layer is semi-cured, and at that condition, the object is provided to a dicing process or a bonding process. Although, In a conventional anisotropic conductive film system, it is necessary to give a tack property to the surface of the adhesive from the necessity of once bonding the film to a substrate, in the present invention, such a process is not necessary, and therefore, it is possible to semi-cure the adhesive at about a degree for facilitating handling or dicing. If the adhesive is maintained at a semi-cured condition, actually up to a timing immediately before bonding process, the uniform spread condition of the conductive particles can be kept, and the handling can also be facilitated. Moreover, although it has been difficult to properly perform dicing for a wafer in the conventional technology because the adhesive adheres to a cutter at the time of dicing, by semi-curing the adhesive, it becomes possible to easily perform the dicing.

When the adhesive is coated by printing and the like, it is preferred to coat it only to necessary portions. For example, it is preferred to coat the adhesive leaving the alignment mark portions for dicing which are located at circumferential positions of the object. If the alignment mark portions for dicing are coated with the adhesive, for example, when a wafer is cut at a predetermined size by dicing or when a chip after dicing is picked up from the wafer, the operation may become impossible or very difficult.

As the conductive particles used in the bonding method according to the present invention, a particle the whole of which is made of a metal (for example, gold) can be used. Alternatively, as the conductive particles, plastic particles coated with a metal (for example, gold) by plating or coating can also be used. Moreover, as the conductive particles, metal particles fusible by heating (namely, particles made of a low-melting point metal and fusible by heating at the time of bonding, for example, particles formed from a solder) can also be used. In a case where infusible conductive particles are used, basically the electrical connection is achieved by press-contact of the conductive particles between both metal joint parts, but in a case where fusible metal particles are used, because the conductive particles can be fused between both metal joint parts by heating after press-contact of the conductive particles, it becomes possible to achieve a better condition in electrical connection after the fused metal is cooled.

In the above-described bonding method using an anisotropic conductive adhesive according to the present invention, first, an adhesive which does not contain conductive particles is coated, and conductive particles are spread uniformly on the surface of the adhesive layer within a predetermined area. Since served to bonding process at that state, even if the adhesive slightly flows to move to portions around metal join parts (for example, bumps) by heating and the like at the time of bonding, the movement is restricted within a very local area, and the adhesive layer does not flow the surface portion greatly. Namely, because the adhesive is coated onto the surface of the object with metal joint parts so that the adhesive layer having a flat surface is formed, the adhesive layer is thin at positions above the metal joint parts and thick at positions except the above-described positions, and therefore, a convex/concave structure is formed on the adhesive layer by convex shapes due to the metal joint parts and relative concave shapes due to the portions except the metal joint parts, and the adhesive layer is formed hard to be flown. Since the conductive particles are spread onto the surface of this adhesive layer, as long as the adhesive layer is hard to be flown, the movement of the conductive particles is also suppressed. Further, at the time of press bonding, it becomes possible to press and crush the conductive particles present on the metal joint parts almost without flowing the conductive particles. Therefore, a great movement of the conductive particles spread on the surface of the adhesive layer can be avoided, and a uniform and desirable spread condition substantially can be maintained. Since the conductive particles maintained at this uniform spread condition are used for electrical connection with another object by being nipped between the metal joint parts as they are, even if the size of each metal joint part is small, a sufficiently large number of conductive particles can be ensured for the electrical connection, and an electrical connection at a high reliability can be achieved surely.

Further, the component, flowing to the circumferential portions of the metal joint parts by heating, etc. at the time of bonding, is restricted to only a local adhesive component, the conductive particles are not contained in this adhesive component, and therefore, a state, such that a relatively large number of conductive particles are unevenly distributed at the portion between bumps adjacent to each other, is not caused. Therefore, even for fine pitching of metal joint parts, an inconvenience such as short circuiting may be surely prevented. As a result, an accommodation for fine pitching of metal joint parts and a high-reliability electrical connection may be both achieved efficiently.

Furthermore, by masking the portions except the metal joint parts on the surface of the adhesive layer, the conductive particles can be efficiently spread only onto the surface portions of the adhesive layer corresponding to the metal joint parts, an inconvenience such as short circuiting may be prevented more surely, and it becomes possible to accommodate fine pitching of metal joint parts more surely. Further, even in a case where the metal joint parts are electrodes each having a flat top surface, the conductive particles may be efficiently spread relatively onto the surface portions of the adhesive layer positioned above and corresponding to the flat top surfaces, and a bonding at a bumpless condition may also become possible.

Thus, in the bonding method using an anisotropic conductive adhesive according to the present invention, even in a case of fine pitching, good electrical connection and prevention of occurrence of inconvenience such as short circuiting may be both achieved surely. Further, by performing an appropriate masking relatively to the surface of the adhesive layer when the conductive particles are spread, the conductive particles may be surely distributed only at necessary portions, and good electrical connection and prevention of occurrence of inconvenience such as short circuiting may be both achieved more surely and at the same time a bonding at a bumpless condition may become possible. Furthermore, since the anisotropic conductive adhesive has been already coated on the object at a desirable condition in the bonding process, it is not necessary to coat it at the bonding process, and therefore, a contraction of time in this process and a contraction of tact time of a series of processes for mounting may become possible.

Brief explanation of the drawings

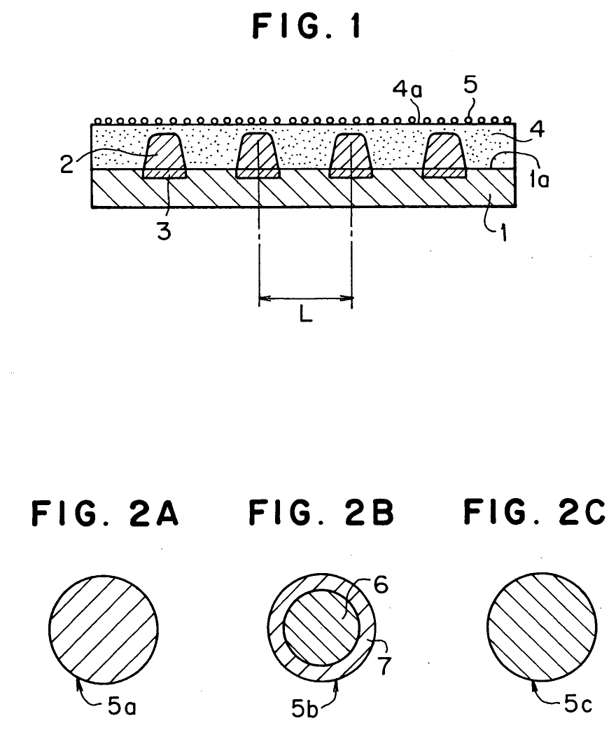

FIG. 1 is a sectional view of an object coated with an anisotropic conductive adhesive showing a method according to an embodiment of the present invention.

FIGS. 2A-2C are sectional views of conductive particles showing various forms thereof.

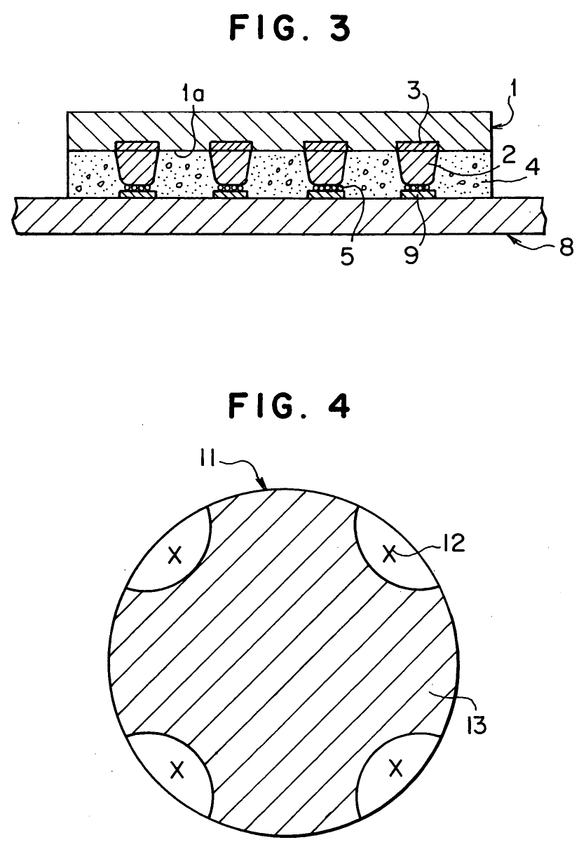

FIG. 3 is a sectional view showing a bonding state where another object is bonded to the object depicted in FIG. 1.

FIG. 4 is a schematic plan view showing an example of coating an adhesive onto a wafer to be cut by dicing.

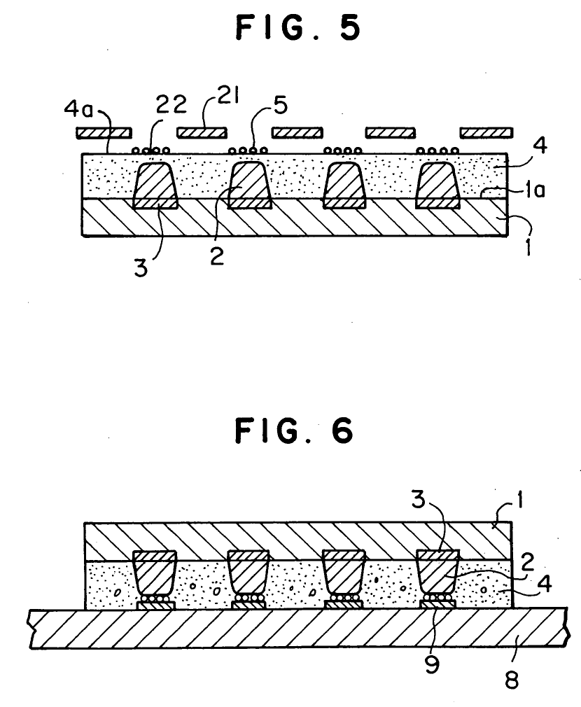

FIG. 5 is a sectional view showing a state where an object is masked and conductive particles are spread thereonto according to another embodiment of the present invention.

FIG. 6 is a sectional view showing a bonding state where another object is bonded to the object depicted in FIG. 5.

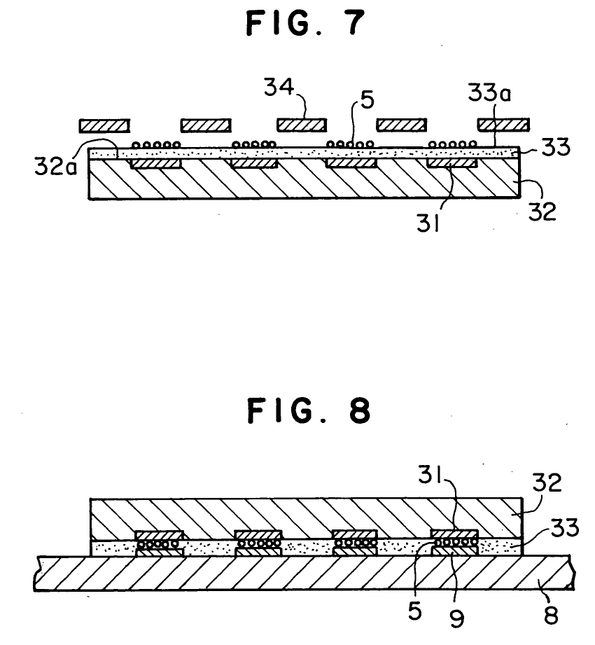

FIG. 7 is a sectional view showing a state where a bumpless object is masked and conductive particles are spread thereonto according to a further embodiment of the present invention.

FIG. 6 is a sectional view showing a bonding state where another object is bonded to the object depicted in FIG. 7.

### THE BEST MODE FOR CARRYING OUT THE INVENTION

Hereinafter, desirable embodiments of the present invention will be explained referring to figures.

FIG. 1 shows a coating method of an anisotropic conductive adhesive in a bonding method using an anisotropic conductive adhesive according to an embodiment of the present invention. In the embodiment shown in FIG. 1, on a surface 1a of an object to be bonded 1 such as a chip or a wafer, a plurality of bumps 2 are provided as metal joint parts in order to achieve a predetermined electrical connection with another object. In this embodiment, each bump 2 is formed on each electrode 3 as a schematic trapezoid or a schematic sphere as shown in the figure. First, an adhesive, which does not contain conductive particles, is coated onto surface 1a of object 1 with bumps 2, and an adhesive layer 4 is formed. This adhesive layer 4 is formed so that the surface 4a extends along the surface of the portions of surface 1a of object 1 in which bumps 2 do not exist, and so that the adhesive layer 4 covers respective bumps 2 completely. It is preferred that the surface 4a of adhesive layer 4 is formed as a surface substantially parallel to the surface 1a of object 1 (the surface in which bumps 2 do not exist) and as a surface as flat as possible. Namely, even if a concave/convex structure is formed by the existence of bumps 2, the surface 4a of adhesive layer 4 is formed preferably as a layer with a flat surface. Further, as described later, it is preferred that the adhesive is not coated relatively to object 1 at undesirable portions, and it is preferred that the adhesive is coated onto only necessary portions at the above-described condition. In order to satisfy such a requirement, it is preferred that the adhesive is coated uniformly at a predetermined thickness onto only the desirable portions at a voidless condition. For example, in a conventional anisotropic conductive film system, voids have been removed by a flow at the time of bonding, but in the method according to the present invention, because the adhesive is hard to be flown, it becomes necessary to coat the adhesive at a voidless condition without involving voids before bonding.

After adhesive layer 4 is formed as described above, conductive particles 5 are spread onto the surface 4a of the adhesive layer 4. It is preferred that conductive particles 5 are spread at a desirable density and uniformly as much as possible. As the method for spreading conductive particles 5 uniformly, for example, raised are a method for spreading them dispersing them uniformly by utilizing a static electricity, a method for spreading them from upper side by spray system, etc. In a case of spray system, it is preferred to spread the particles from upper side with an appropriate distance, thereby easily obtaining a more uniform dispersion condition. By such a spreading, conductive particles 5 are maintained at a condition adhering to the surface 4a of adhesive layer 4, and the condition becomes substantially the same condition of a case where an anisotropic conductive adhesive is coated.

Although it is possible to serve object 1 coated with the anisotropic conductive adhesive to a bonding process at this state, it is preferred to push the spread conductive particles 5 so as to bury them into adhesive layer 4 using an appropriate means such as a pressing plate which has a surface that does not adhere to the conductive particles 5. Further, in this case, heating is preferably employed at a degree which does not influence a post process. By this, conductive particles 5 become hard to be fallen when handling object 1, and a predetermined dispersion state may be easily maintained. Further, after spreading conductive particles 5, it is also preferred to serve object 1 to a bonding process after semi-curing the adhesive component of adhesive layer 4. By the semi-cure, the adhesive component itself may be maintained at a condition hard to be flown, and the conductive particles 5 spread onto the surface 4a of adhesive layer 4 are maintained at a uniform and desirable dispersion condition, and further, the handling becomes easy. In a case where the above-described pushing of conductive particles 5 is carried out, this semi-cure may be performed together with, or before or after the pushing. As aforementioned, in a conventional anisotropic conductive film system, it has been necessary to give a tack property to the surface of the adhesive from the necessity of once bonding it to a substrate, but in the method according to the present invention, such an operation is not necessary, and it becomes possible to semi-cure the adhesive at a degree facilitating handling or dicing. Moreover, although the adhesive adheres to a cutter at the time of dicing of a wafer and the dicing is almost impossible in the conventional technology, in the present invention, it becomes possible to easily perform dicing by semi-curing the adhesive.

As conductive particles 5, particles with various forms can be employed as shown in FIGS. 2A-2c. Conductive particle 5a shown in FIG. 2A is formed as a particle the whole of which comprises a metal excellent in conductivity (for example, Ni). Conductive particle 5b shown in FIG. 2B is formed as a particle in which a layer 7 of a metal excellent in conductivity (for example, Ni/Au) is coated on the surface of a particle 6 composed of an appropriate plastic. The coating of metal layer 7 may be performed by plating, coating or other appropriate methods. Conductive particle 5c shown in FIG. 2C is formed as a particle comprising a metal fusible by heating (for example, a low-melting point metal such as a solder). In a case where conductive particles 5c are used, the metal joint parts of both objects may be bonded to each other by fusing the conductive particles 5c by heating in the next bonding process.

Object 1 thus coated with the anisotropic conductive adhesive is heated and pressed in the bonding process, and bonded to the other object, for example, as shown in FIG. 3. In the example shown in FIG. 3, the direction of object 1 spread with conductive particles 5 shown in FIG. 1 is turned over vertically, and bumps 2 of object 1 are bonded to electrodes 9 of the other object 8 via the conductive particles 5. In this bonding process, although conductive particles 5 present on bumps 2 are pressed as they are and adhesive layer 4 is heated and pressed, at that time, even if the adhesive component of adhesive layer 4 becomes a condition easy to be flown, the flow is restricted to a local flow to the surrounding portions, and even if such a flow occurs, the flow at the surface 4a of the adhesive layer 4 becomes an extremely small flow, or the flow may be substantially suppressed. Namely, as aforementioned, because a concave/convex structure due to bumps 2 exists in adhesive layer 4 whose surface 4a is formed to be flat, the adhesive layer 4 becomes hard to be flown, conductive particles 5 are dispersed and held on the surface 4a of the adhesive layer 4 hard to be flown, and therefore, the conductive particles 5 also become hard to be flown. Therefore, conductive particles 5 spread onto the surface 4a of the adhesive layer 4 do not move greatly, and are maintained at a uniform and desirable dispersion condition. Since bumps, or, bumps and electrodes, of both objects are bonded to each other at this condition, even if the size (area) of bump is set to be extremely small, the number of conductive particles 5 nipped therebetween is maintained at an adequate number (for example, five or more conductive particles 5 are surely nipped). Namely, the conductive particles 5 exist within a small area at an adequately high density, thereby achieving a high-reliability and target excellent electrical connection.

Further, even if there occurs a small local flow of the adhesive component in adhesive layer 4, because conductive particles 5 are not contained in this adhesive component, the above-described excellent electrical connection is not affected. Moreover, since conductive particles 5 contributing to the electrical connection positionally exist at a formation in which they are nipped between bumps, etc. of both objects to be bonded to each other, even if the above-described local flow of the adhesive component occurs, the movement toward the portions between bumps 2 of object 1 accompanying with the flow is prevented and the particles are not unevenly distributed. Therefore, even in a case of fine pitching, that is, even if the pitch L of bumps 2 in FIG. 1 is set to be extremely small (for example, at a pitch of 35 μm or less), occurrence of inconvenience such as short circuiting between bumps 2 may be surely prevented. As a result, fine bump 2 and fine pitching of bumps 2 may be both accommodated.

In the above-described method, it is preferred that the coating of the adhesive by printing and the like is carried out only to necessary portions of the object. For example, in a case where the object is a wafer which is cut at a predetermined size by dicing, for example as shown in FIG. 4, alignment marks 12 for dicing are provided at the circumferential portions of wafer 11 before cutting. Therefore, if the adhesive is coated up to the portions of alignment marks 12 for dicing, because the operation for cutting at a predetermined size by dicing becomes impossible, it is preferred to coat adhesive 13 only to the necessary portions leaving these portions.

Further, although conductive particles 5 are spread over almost the entire surface 4a of the coated adhesive layer 4 in the above-describe embodiment, the spreading may be carried out only to the necessary portions by performing masking. For example, as shown in FIG. 5, after adhesive layer 4 is formed relatively to object 1 shown in FIG. 1, by providing a mask 21 on the portions except portions above and corresponding to bumps 2, it becomes possible to spread conductive particles 5 only onto non-masking portions 22. By bonding such an object 1 thus spread with conductive particles 5 to the other object 8 accompanying with heating and pressing as shown in FIG. 6, even if the conductive particles 5 escape to the portions around bumps 2, the number of conductive particles existing between adjacent bumps 2 may be suppressed smaller. Therefore, fine pitching of bumps 2 may be accommodated more surely. Further, because conductive particles 5 are spread only onto specified non-masking portions 22, the density of spreading can be easily increased, the density of the distributed conductive particles 5 used for electrical connection can be increased, an excellent electrical connection can be ensured even for fine bumps, and the formation of fine bumps may be accommodated.

Further, although object 1 formed with bumps 2 is used in both the above-described embodiments, in the method according to the present invention, by performing the above-described masking, a bonding at a bumpless condition becomes possible. For example, as shown in FIG. 7, a relatively thin adhesive layer 33 is formed on the surface 32a of object 32 having electrodes 31 (for example, Al electrodes) on a chip circuit, mask 34 is provided relatively to the surface 33a, and conductive particles 5 are spread only onto the portions corresponding the upper portions of the electrodes 31 in the surface 33a. Then, as shown in FIG. 8, object 32 spread with conductive particles 5 may be bonded to the other object 8 via the conductive particles 5 so that electrodes 31 and electrodes 9 are electrically connected to each other. When bonded, because conductive particles 5 are interposed only to the portions necessary for the electrical connection, electrodes 31 and electrodes 9 are efficiently bonded to each other, and because the conductive particles 5 do not exist on the other portions, an inconvenience such as short circuiting does not occur. Further, because adhesive layer 33 may be formed as a thin layer, a local flow of the adhesive layer 33 becomes hard to occur, and also from this point of view, good electrical connection and prevention of inconvenience such as short circuiting can be achieved surely. Moreover, by the thin adhesive layer 33, a gap between objects to be bonded to each other may be reduced, and such an optimum condition may be achieved for the field of three-dimensional mounting, etc. which requires a thin package. Furthermore, by making adhesive layer 33 thin, it becomes possible to shorten the time required for the bonding process because the heating time can be shortened. Thus, by spreading conductive particles 5 at a masking condition, a bumpless bonding becomes possible.

Further, in the above-described respective embodiments, by using metal particles fusible by heating as conductive particles 5 as aforementioned, it becomes possible to achieve a further ensured electrical connection via the fused metal.

### INDUSTRIAL APPLICATIONS OF THE INVENTION

The bonding method using an anisotropic conductive adhesive according to the present invention is an optimum method particularly for a mounting using chips, wafers and various substrates, especially useful for a mounting in a case where fine metal joint parts and fine pitching are required. Further, also in a case where the time of bonding process is required to be shortened, the present invention is extremely useful.

1. A bonding method using an anisotropic conductive adhesive when bonding objects each having metal joint parts to each other, comprising the steps of:
forming an adhesive coating layer on and along a surface, having said metal joint parts, of at least one of said objects;
spreading conductive particles onto a surface of said adhesive layer; and
bonding said metal joint parts to each other.

2. The bonding method using an anisotropic conductive adhesive according to claim 1, wherein a predetermined masking is performed relatively to said surface of said adhesive layer, and said conductive particles are spread onto non-masking portions corresponding to positions of said metal joint parts.

3. The bonding method using an anisotropic conductive adhesive according to claim 2, wherein said masking is performed by using a perforated plate.

4. The bonding method using an anisotropic conductive adhesive according to claim 2, wherein said masking is performed by selectively changing tack properties between surface portions of said adhesive layer by exposure.

5. The bonding method using an anisotropic conductive adhesive according to claim 2, wherein portions, to which said masking is performed, include a mark portion for alignment of said object.

6. The bonding method using an anisotropic conductive adhesive according to claim 1, wherein said metaljoint parts of said at least one of said objects are formed as bumps.

7. The bonding method using an anisotropic conductive adhesive according to claim 1, wherein said metal joint parts of said at least one of said objects are formed as electrodes each having a flat surface.

8. The bonding method using an anisotropic conductive adhesive according to claim 1, wherein, after said conductive particles are spread, the spread conductive particles are pushed into said adhesive layer.

9. The bonding method using an anisotropic conductive adhesive according to claim 1, wherein, after said conductive particles are spread or after the spread conductive particles are pushed into said adhesive layer, said surface of said adhesive layer or the entire adhesive layer is semi-cured.

10. The bonding method using an anisotropic conductive adhesive according to claim 1, wherein said adhesive is coated by printing.

11. The bonding method using an anisotropic conductive adhesive according to claim 10, wherein said adhesive is coated by vacuum printing.

12. The bonding method using an anisotropic conductive adhesive according to claim 1, wherein said adhesive is coated at a condition leaving mark portions provided on circumferential portions of said object for alignment at the time of dicing.

13. The bonding method using an anisotropic conductive adhesive according to claim 1, wherein metal particles are used as said conductive particles.

14. The bonding method using an anisotropic conductive adhesive according to claim 1, wherein plastic particles coated with a metal are used as said conductive particles.

15. The bonding method using an anisotropic conductive adhesive according to claim 1, wherein metal particles fusible by heating are used as said conductive particles.
